(19) United States
(12) Patent Application Publication
(10) Pub. No.: US 2023/0255148 A1
(43) Pub. Date: Aug. 17, 2023

(54) PRODUCE PRODUCTION CAROUSEL

(71) Applicant: Clearly Grown, Inc., Burnsville, MN (US)

(72) Inventors: Joseph Alexander Eilts, Oakdale, MN (US); James Paul Hewitt, Burnsville, MN (US)

(21) Appl. No.: 17/670,653

(22) Filed: Feb. 14, 2022

(51) Int. Cl. A01G 9/04; A01G 31/04; A01G 9/24

(52) U.S. Cl. CPC A01G 9/047; A01G 31/04; A01G 9/249

(57) ABSTRACT

A system and related methods for increasing the density and efficiency of horticultural production in greenhouse/glasshouse/conservatory settings comprising an upper conveyor and a lower track that allow for the movement of plants/crops through a greenhouse system to thereby create a more consistent growing environment.

### TECHNICAL FIELD

This disclosure relates generally to devices, systems, and/or methods for improving the productivity or efficiency of plant growth in certain environments, such as greenhouses, glasshouses, conservatories, and the like. More particularly, this disclosure describes embodiments utilizing a conveyor system to move plants/crops along a conveyor path in a manner that provides a more consistent growing environment, thereby increasing the density and efficiency of horticultural production.

### BACKGROUND

The cultivation of plants using limited resources is a known concern. Increasing the efficiency and productivity of growing plants and crops is a continuing challenge, particularly in environments with constraints on various factors such as space, lighting, water, nutrition, etc. The production of plants in greenhouses or glasshouses, for example, highlights the challenge of attempting to maximize the yield of a given space in terms of plant production, while minimizing the inputs and costs associated with such efforts (capital, labor, electricity, water, etc.).

Prior attempts to maximize the productivity of plant production have included a plant growing room, such as the apparatus described in U.S. Pat. No. 6,173,529 (“Kertz”). Kertz discloses a plurality of growing sheets that hang vertically from a frame having a plurality of supports for supporting the growing sheets.

Further attempts to improve the productivity of plant production have included a track assembly, such as the apparatus described in International Pub. No. WO 2010/097562 to Bradford et al. (“Bradford”). Bradford describes a plurality of support assemblies mounted to and moveable along the track assembly, each support assembly having a removable receptacle for holding plants.

U.S. Pat. No. 10,638,677 (“Storey”) describes a grow tube apparatus for facilitating vertical hydroponic plant growth in greenhouse environments.

### SUMMARY

This disclosure describes a system for the cultivation of plants. A system for the cultivation of plants may comprise, for example, an upper closed-loop track assembly comprising a track and a drive means for moving the track along a continuous path. The system may include a lower closed-loop path disposed beneath the upper closed-loop track assembly, the lower closed-loop path conforming to the continuous path and having a width extending horizontally outward from the continuous path. The system may include a plurality of longitudinal plant receptacles, each plant receptacle having an upper end and a lower end, the upper end removably suspended from the track and configured to move with movement of the track along the continuous path. The lower end of the plant receptacles may be configured to follow passively along the lower closed-loop path. The lower end of the plant receptacles may be disposed horizontally outward a predetermined distance from the continuous path. The longitudinal plant receptacles may thereby be positioned at an angle from the lower end to the upper end that facilitates exposure to an overhead light source.

The plant production apparatus disclosed herein may allow for the movement of crops through a limited space (e.g., a greenhouse structure) thereby creating a more consistent growing environment, increasing yields, decreasing labor requirements, and improving worker access to the crops. The plant production apparatus disclosed herein may be well-suited for “multi-harvest” crop production, for example strawberries or peppers, where a crop is grown and harvested multiple times. The plant production apparatus disclosed herein may provide a suitable platform for horticulture use when used in conjunction with gutter-style hydroponic plant growth systems. The growing angle and/or the near-continuous movement of plant receptacles provided by the plant production apparatus may, for example, reduce shading of lower positioned plants from upper positioned plants, as would be the case in a solely vertical arrangement.

Although some of the benefits of the plant production apparatus disclosed herein may apply to multi-harvest crops, the apparatus could also be used in conjunction with the production of single-harvest crops.

The plant production apparatus disclosed herein may allow for the more efficient use of natural lighting sources (e.g., sunlight), although it could also be used in conjunction with artificial lighting. Similarly, the plant production apparatus could be employed in both indoor and outdoor settings.

### BRIEF DESCRIPTION OF DRAWINGS

FIGS. 1A and 1B are schematic perspective views of a plant production apparatus according to some embodiments of this disclosure.

FIGS. 2A-2E are overhead plan views of a number of exemplary closed-loop paths that may be employed according to various embodiments of this disclosure.

FIG. 3 is a perspective view of a plant production apparatus according to some embodiments of this disclosure.

FIGS. 4A-4E are sides views of a plant support frame for use with a plant production apparatus in accordance with exemplary embodiments of this disclosure.

FIGS. 5A-5C are perspective views of an exemplary plant support frame for use with a plant production apparatus in accordance with an exemplary embodiment of this disclosure.

### DETAILED DESCRIPTION

This disclosure describes a plant production apparatus for moving plants through a limited growing space (e.g., a greenhouse structure) in an angled, upright orientation to thereby provide a more consistent growing environment, improving the efficiency of such growing operations, increasing yields, decreasing labor requirements, and/or improving worker access to the plants.

In some embodiments, the plant production apparatus comprises an upper conveyor track forming a closed-loop path, a drive system to cause the upper conveyor track to move along the closed-loop path, and a plurality of plant receptacles supported and descending from the upper conveyor track to form an angle from vertical, whereby the plant receptacles are caused to move around the closed-loop path by movement of the upper conveyor track. The angle formed by the plant receptacles may be chosen, for example, to present a suitable grow face of the plant receptacles to available light sources, and to thereby provide more uniform exposure to available light sources, such as from the sun, and/or to avoid shading effects in lower portions of a plant receptacle caused by plant growth in upper portions of a plant receptacle. The plant receptacles may be longitudinal, gutter-type plant receptacles, such as the vertical grow tube apparatus described in Storey. The present disclosure is not so limited, and other plant receptacles of varying configurations and shapes could be employed. For example, various types of generally vertically-oriented, “gutter” style hydroponic equipment exists on the market and could be employed in conjunction with various embodiments of this disclosure.

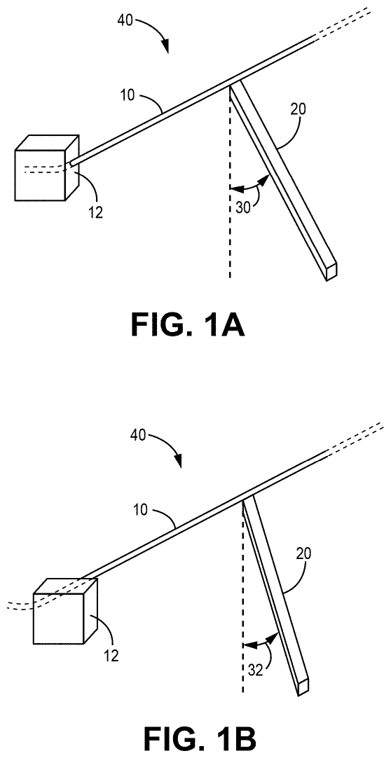

FIGS. 1A and 1B show schematic perspective views of a plant production apparatus 40 according to some embodiments. FIG. 1A shows a longitudinal plant receptacle 20 supported from (directly or indirectly) and descending from an upper conveyor track 10 and forming an angle 30 from a vertical orientation. Upper conveyor track 10 is operably engaged with a drive system 12 and is configured to be driven by drive system 12 to move along a defined closed-loop path. Drive system 12 may, for example, comprise one or more motors (e.g., electric, gas-powered, etc.) with suitable gearing and connectors to enable it to move upper conveyor track 10 along the closed-loop path at a desired range of speeds. The speed for moving the plant receptacles 20 along the closed-loop path can range anywhere from around 0.1 meters per min (m/min) to about 5 m/min, typically in a range from about 0.4 to 1.5 m/min. Other comparable drive means for moving track 10 about the closed-loop path would be apparent to those of ordinary skill in the art.

An example of a longitudinal plant receptacle 20 that may be suitable for use with plant production apparatus 40 includes vertical growing towers made by ZipGrow™, as one possible example, but could also include a variety of gutter-type grow systems as are known by those of skill in the art.

FIG. 1B shows the same arrangement as FIG. 1A except that a different angle 32 has been employed for the positioning of longitudinal plant receptacle 20. The particular angle chosen (e.g., angle 30 or 32, or other angles) may depend on a number of factors, such as the angle of expected light exposure (e.g., due to the angle of the sun during various seasons), or the type of crop, or the geographic location, or other factors, as desired to optimize light availability and efficient use of growing space. The angle may be formed, maintained, or adjusted in a number of ways, as will be described in more detail in this disclosure.

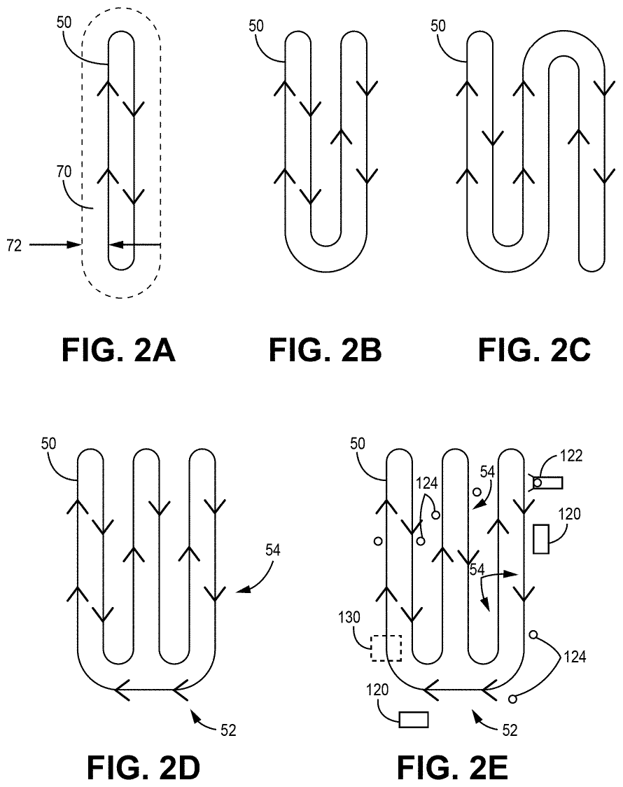

FIGS. 2A-2D are overhead plan views of a number of exemplary closed-loop paths 50 that may be employed according to some embodiments of this disclosure. As used herein, closed-loop path 50 refers to the generally horizontal path (also referred to as the “transit path”) followed by the upper conveyor track 10 (FIGS. 1A and 1B) as it is moved by drive system 12 throughout the growing space. As shown in FIG. 2A, upper closed-loop path 50 may further define a lower closed-loop path 70 disposed beneath upper closed-loop path 50, having a width 72. For example, lower closed-loop path 70 may include a range of paths of travel of the lower portions of plant receptacles 20 disposed at various angles 30, 32. It should be noted that, in certain contexts, closed-loop path 50 may refer to either the path of travel of upper conveyor track 10, or to a path directly below conveyor track 10, e.g., to define an inner portion of lower closed-loop path 70.

FIG. 2A shows a generally oval path for closed-loop path 50, while FIGS. 2B-2D show other shapes or patterns that could be used to form closed-loop path 50, including U-shaped, zig-zag, and serpentine paths of travel. In some embodiments, it may be beneficial to have one or more generally long, straight portions connected by relatively short, curved portions, for example, in order to optimize or maximize the productivity of a given growing space. In some embodiments, it may be desirable to have generally straight portions positioned to facilitate worker access at certain locations, or to facilitate certain aspects of plant production, such as harvesting, watering, planting, etc.

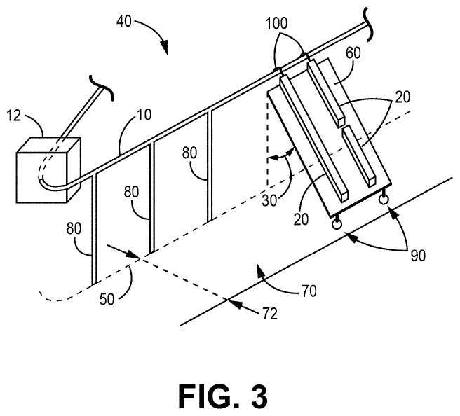

FIG. 3 is a perspective view of a portion of a plant production apparatus 40 according to some embodiments. For example, upper conveyor track 10 is shown in FIG. 3 defining a portion of closed-loop path 50. Drive system 12 is shown providing the means for moving upper conveyor track 10 about the closed-loop path 50. A number of longitudinal plant receptacles 20 are shown descending from track 10 at angle 30 such that their lower portions tend to travel in a path that extends horizontally outward a distance from the closed-loop path 50. In some embodiments, lower path 70 could be defined as having a width 72 extending horizontally outward from path 50.

FIG. 3 shows a number of optional or alternate elements of plant production apparatus 40 according to various embodiments. For example, upper conveyor track 10 may be supported by a plurality of track support posts 80 positioned along closed-loop path 50. The track support posts 80 may be spaced along closed-loop path 50 in sufficient quantity and appropriate spacing to provide adequate structural support for the plant production apparatus 40. The track support posts 80, by being self-supporting, may enable a plant production apparatus 40 according to this disclosure to be used in multiple types of housings or structures, for example, regardless of the load bearing capacity of the structure itself. In some portions of the closed-loop path 50, it may be possible for a single track support post 80 to be configured to support upper conveyor track 10 moving in opposite directions on two sides of the track support post 80. This may, for example, be possible along relatively straight portions of closed-loop path 50 (such as portion 54 in FIG. 2D) where the conveyor track 10 is “doubling back” along its route. Along such straight portions 54 of closed-loop path 50, the plant production apparatus 40 may appear to have a cross-sectional “A-frame” structure formed by the plant receptacles 20 extending downward at an angle on either side of a row of track support posts 80, for example. The A-frame structure may tend to more efficiently use the available growing space, minimizing any dead space that may otherwise exist between portions of the closed-loop path 50. However, it may not be possible to maintain this “A-frame” structural appearance in all portions of closed-loop path 50, such as in end portion 52 shown in FIG. 2D, where one or more track support posts 80 would likely be employed having upper conveyor track 10 moving in a single direction along the length of end portion 52, for example.

In some alternate embodiments (not shown), upper conveyor track 10 may be supported by a plurality of track supports that hang from a position above track 10, for example, from an overhead beam or rafter or other available structure from which the plant production apparatus 40 may be supported. Such an arrangement may, for example, provide additional space for accessing the plants or for performing maintenance on the plant production apparatus 40.

Also shown in FIG. 3 is an exemplary plant support frame 60. Plant production apparatus 40 may include a plurality of plant support frames 60 disposed along closed-loop path 50. Each plant support frame 60 may have an upper portion which may be supported by conveyor track 10 and configured to descend downwardly from track 10 at an angle 30. Plant support frame 60 may be configured to support one or more plant receptacles 20, as shown in FIG. 3, such that plant receptacles 20 are maintained at angle 30 from a vertical orientation. Plant receptacles 20 may comprise longitudinal, gutter-type receptacles or grow tubes, for example. In some embodiments, a single, long, gutter-type plant receptacle 20 may be releasably attached to plant support frame 60, and such a receptacle 20 may extend substantially the vertical length of plant support frame 60. “L”-shaped or “Z”-shaped brackets may be used to releasably attach the plant receptacles 20 to the plant support frames 60, for example. Other comparable releasable coupling mechanisms could also be employed for this purpose, as would be apparent to those of ordinary skill in the art. In some embodiments of this disclosure, two or more plant receptacles 20 may be placed in a vertical arrangement on plant support frame 60, as is shown in the example of FIG. 3. L-brackets, Z-brackets, or comparable attachment means may be employed to releasably attach, reposition, and/or remove the plant receptacles 20 from plant support frame 60 on an as-needed basis. In some embodiments, plant support frame 60 may be configured to only hold a single plant receptacle 20 in a substantially vertical arrangement; that is, plant support frame 60 may have a narrow width suitable for supporting a single, elongate plant receptacle 20, or for supporting a single vertical column comprising two or more plant receptacles, for example. Such a narrow plant support frame 60 may, for example, allow for closer spacing between adjacent plant support frames 60 as they move around track 10. In some alternate embodiments, plant support frame 60 may be configured to support two or more vertical columns of plant receptacles 20, or two or more elongate plant receptacles 20 in a side-by-side fashion, if so desired.

Each plant support frame 60 is further configured to be driven by movement of track 10 by drive system 12, such that each support frame 60 is moved along closed-loop path 50. In some embodiments, plant support frame 60 comprises a lower portion that is configured to passively follow the movement driven by track 10 to enable plant support frame 60 to maintain its angled orientation during movement. For example, the lower portion of plant support frame 60 may travel within the lower closed-loop path 70 during such movement. The lower portion of plant support frame 60 may travel in this manner a horizontal distance outward from path 50, typically within a path width 72 of lower path 70.

In some embodiments, each plant support frame 60 may be operably engaged with upper conveyor track 10 via one or more releasable track couplings 100, as indicated in FIG. 3. The releasable track couplings 100 may take a variety of forms and may vary depending on other aspects of the plant production apparatus 40. For example, upper conveyor track 10 may comprise an enclosed motorized track, or a motorized I-beam style overhead track, as would be familiar to those of ordinary skill in the art. In some embodiments, a simple hook style attachment may suffice for the releasable track couplings 100. In some other embodiments, it may be desirable to have an adjustable fastener (e.g., a hinge and bolt arrangement) that facilitates adjustment of the angle 30 at the releasable track couplings 100, for example. Such an arrangement may, for example, allow a change or adjustment to the angle 30 (e.g., by movement at the point of a hinge, by loosening and tightening a bolt at the hinge, etc.) in a direction generally perpendicular to the path of track 10, while maintain a generally rigid engagement or coupling in the direction of the path 50 of track 10.

Each plant support frame 60 may have one or more carrying idlers 90 disposed at a lower portion of plant support frame 60 to facilitate passive following of the lower portion of plant support frame 60 along lower path 70. Carrying idlers 90 may comprise casters, or roller wheels, or low-friction elements for sliding along a surface of lower path 70, or other comparable mechanisms to facilitate movement of a lower portion of plant support frame 60 along lower path 70 in response to the upper portion of support frame 60 begin driven by track 10.

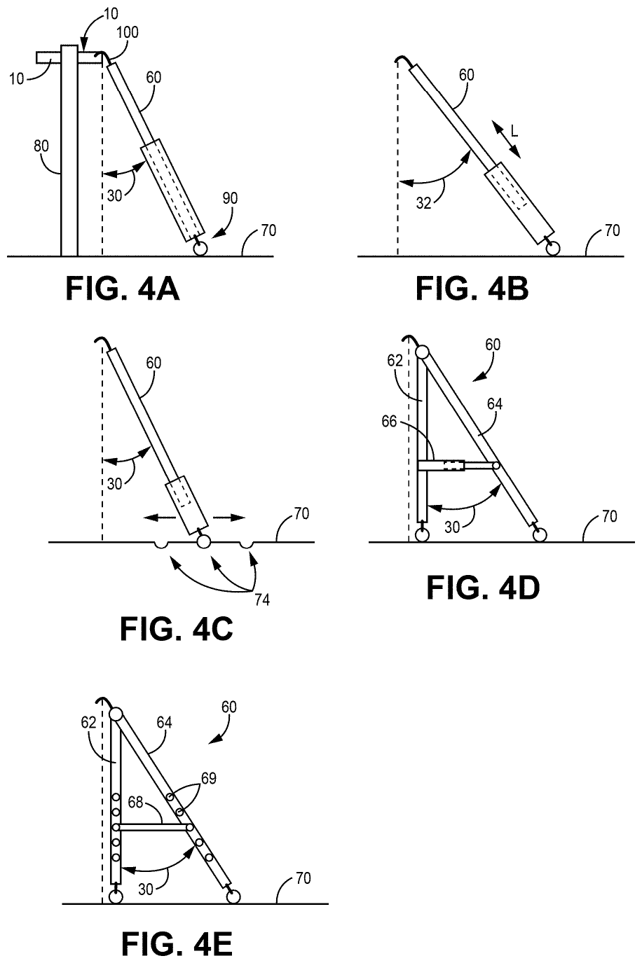

FIGS. 4A-4E illustrate several different examples of plant support frames 60 that could be employed with plant production apparatus 40. The embodiments shown in FIGS. 4A-4E illustrate a number of ways in which the angle 30 at which plant support frame 60 is disposed may be adjusted to a different angle. FIG. 4A shows a plant support frame 60 comprising telescoping upper and lower portions that are slidably received one within the other. In FIG. 4A, angle 30 is formed as a result of plant support frame 60 being operably coupled to upper conveyor track 10 via releasable track couplings 100, and descending downward at angle 30 to a point at which carrying idler 90 is in contact with lower path 70. In FIG. 4B, the length “L” of plant support frame 60 has been changed (e.g., lengthened or shortened) by slidable movement of upper and lower portions of frame 60 with respect to each other, resulting in a different angle 32. FIG. 4C shows a similar arrangement as in FIGS. 4A and 4B, with the addition of tracks or guides 74 formed in lower path 70 to guide the travel of carrying idlers 90 during travel along lower path 70. As depicted in the example of FIG. 4C, the tracks or guides 74 could be formed as depressions in a surface of lower path 70. Alternatively, the tracks or guides 74 could be formed as additional components, such as a rail or rails, that are disposed on a surface of the lower path 70, and within which the carrying idlers 90 would be configured to travel. FIGS. 4D and 4E provide additional alternate plant support frames 60 having a vertical portion 62 and a sloping portion 64, and a lateral adjustment member 66 or 68 for changing the angle 30 formed between portions 62 and 64. For example, in FIG. 4D, lateral adjustment member 66 may comprise outer and inner telescoping portions that enable varying the angle 30. FIG. 4E shows a lateral adjustment member 68 that may be positioned within a number of selectable detent positions or holes 69 in portions 62 and 64 of support frame 60 to thereby adjust the angle 30 formed.

Some of the embodiments shown in FIGS. 4A-4E could optionally include a hydraulic or pneumatic system (not shown) to facilitate changing the angle 30 at which the plant support frame 60 is presented. For example, the telescoping upper and lower portions of the plant support frame 60 of FIG. 4A-4C could be moved relative to each other (e.g., either increasing or decreasing the extent to which they are slidably received one within the other) via the use of pneumatic or hydraulic actuators as are known to those of skill in the art. Similarly, the lateral adjustment members 66 and 68 of FIGS. 4D and 4E, respectively, could be actuated to change angle 30 using known pneumatic or hydraulic actuator systems. The use of pneumatic or hydraulic actuators to control the angle 30 of plant support frames 60 (and therefore, plant receptacles 20 disposed thereon) could facilitate adjustment of the angle 30 throughout the plant production apparatus 40 and could further enable a degree of automation to the process of controlling and/or adjusting the angle 30 (e.g., in response to changing lighting conditions or other environmental factors).

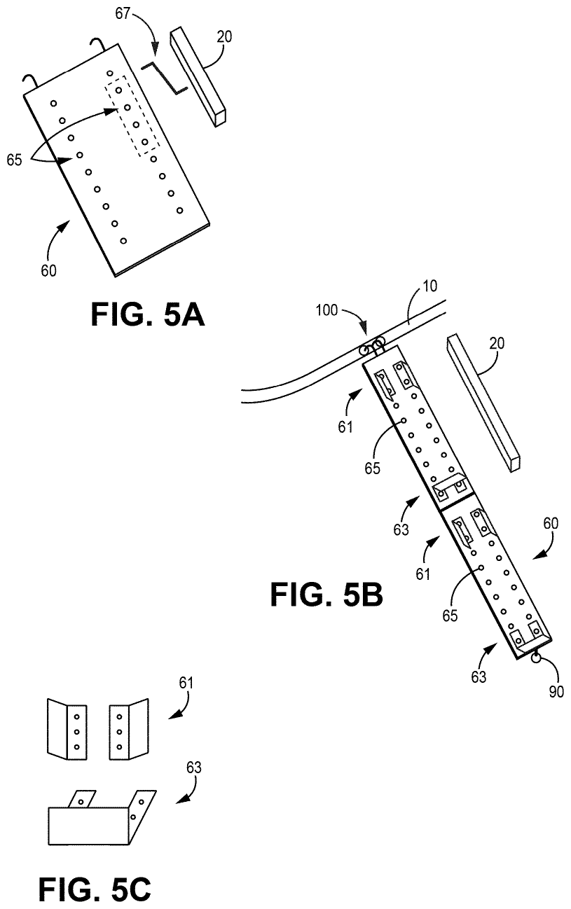

With reference now to FIG. 5A, a plant support frame 60 is shown having a plurality of mounting holes 65 disposed about an upward facing surface of plant support frame 60. A plant receptacle 20 is shown in FIG. 5A with a proposed placement on plant support frame 60 indicated in dashed line. Plant receptacle 20 may be releasably coupled or mounted to plant support frame 60 through the use of one or more of the mounting holes 65. For example, one or more suitable mounting brackets 67, such as L-brackets or Z-brackets or other comparable attachment means, could be positioned in mounting holes 65 to provide a way of attaching plant receptacles 20 to a surface of the plant support frame 60. An angled portion of the bracket 67 may be configured to mate with or latch into a corresponding groove or opening in a portion of the plant receptacle 20 to thereby enable releasable attachment to the plant support frame 60. Other releasable attachment mechanisms could also be employed. A releasable attachment mechanism like mounting brackets 67 may facilitate the placement, removal, and/or repositioning of plant receptacles 20 on a surface of plant support frame 60, for example as suggested by FIG. 5A. The mounting brackets 67 and mounting holes 65 could be used to support single long gutter-style plant receptacles 20, or could alternately be used to support two or more plant receptacles positioned in a vertical column, for example.

With reference now to FIGS. 5B and 5C, a plant support frame 60 according to some embodiments of this disclosure is depicted. For example, plant support frame 60 is configured to support a single vertical column of plant receptacles 20 (including a single long plant receptacle 20 in some embodiments). As noted previously, a plant support frame 60 configured in this manner may enable placement of more plant support frames 60 (e.g., in a denser pattern along path 50), and/or may facilitate better handling characteristics at any turns or curves in the path 50, for example. FIG. 5B shows plant receptacle 20 being a “gutter” style plant receptacle, configured to be placed and supported on plant support frame 60 via L-brackets 61 and 63, substantially as shown in FIG. 5B. In the example shown, a pair of side rail L-brackets 61 may be coupled to plant support frame 60 (e.g., via bolts or other suitable fastening mechanisms) to hold plant receptacle 20 in a substantially vertical alignment on an upward-facing surface of plant receptacle 60. Also shown in the example of FIG. 5B is a lower footing plate L-bracket 63, configured to be coupled to plant support frame 60 (e.g., via bolts or other suitable fastening mechanisms) to support plant receptacle 20 at a bottom portion thereof, according to some embodiments.

Plant production apparatus 40 may, in some embodiments, further comprise one or more watering/feeding stations and, optionally, a drainage system. Referring to FIG. 2E, one or more watering/feeding stations 120 may be disposed along path 50. For example, watering/feeding stations 120 may be preferably located at straight sections, such as straight portions 54 or end portions 52 illustrated in the path 50 of FIG. 2E. The water and feed supply could include any variety of mechanisms for delivering water and/or nutrients to the plants in the plant receptacles 20 as they are moved along path 50. In some embodiments, the plant receptacles 20 may comprise generally vertically-oriented, longitudinal receptacles such as vertical gutters or vertical grow tubes. In such embodiments, watering/feeding stations 120 may take advantage of the generally vertical orientation of the plant receptacles 20, enabling the water and/or nutrients to be supplied at an upper end of the plant receptacle and trickle downward through the plant receptacle 20, thereby minimizing wastage due to evaporation and/or other factors.

In some embodiments, the positioning of a limited number of (or only one) watering/feeding station 120 along the closed-loop path 50 may enable accurate control of the watering and feeding process, including possibly tracking the precise amounts of fluids and nutrients dispensed. Further, the plant receptacles 20 may be equipped with an identification technology (e.g., bar code, QR codes, RFID, etc.) to further enable tracking and monitoring of fluid and nutrient delivery. In some embodiments, for example, one or more sensors 122 (e.g., RFID, bar code, QR code, light sensors, etc.) may be disposed along path 50 at certain positions, such as depicted in FIG. 2E. A sensor 122 may be positioned along path 50 to read identifying information from a particular plant receptacle 20. Sensor 122 may be positioned on track 10, or along a support beam (e.g., supporting track 10), or in other possible locations chosen so as to enable sensor 122 to read the identifying information provided on a particular plant receptacle, for example. In certain embodiments of this disclosure, light sensors 124 may optionally be disposed along path 50 to provide data on the intensity and/or the evenness of light across the system. Such data regarding the evenness or distribution of light received by the plants may enable an operator of plant production apparatus 40 to adjust operational aspects such as the angle 30 of the plant receptacles 20, or the speed of movement of plant receptacles along path 50, etc., to create better light distribution across the system. Further, such data may enable the automatic adjustment of these same operational parameters. Optionally, or additionally, the sensing and detection (e.g., via any of the above-mentioned identification technologies) of specific plant receptacles 20 as they move and approach a watering/feed station 120 may facilitate the precise timing of delivery of water and/or nutrients. For example, a scanning sensor that detects a particular plant receptacle approaching may be able to time the delivery of water and/or nutrients so that it is directed straight into the top of the plant receptacle 20 thereby minimizing spillage and wastage, and to optionally control the precise amounts of fluid and nutrients delivered based on knowledge of the history of the particular plant in the specific plant receptacle approaching, etc.

In optional embodiments, a drainage system 130 may be employed with plant production apparatus 40, particularly in conjunction with the use of watering/feeding station 120. Drainage system 130 may, for example, enable recovery and possible reuse of water and nutrients that drain from the lower portions of plant receptacles 20, according to some embodiments. Drainage system 130 may comprise, for example, a collection device disposed at a lower portion of a plant support frame 60 which collects run-off water and nutrients, then periodically directs the drainage to a central collection device for processing and potential re-use, according to some embodiments. For example, a collection device (not shown) holding run-off water and nutrients from a given plant support frame 60 may be triggered to periodically release its contents into a drainage system or receptacle 130. A sensor 122 could for example, be positioned proximate drainage system 130 to enable timing the release of the contents of such a collection device into drainage system upon reaching an appropriate point in its travel along path 50.

Various examples have been described. These and other variations that would be apparent to those of ordinary skill in this field are within the scope of this disclosure.

What is claimed is:

1. A system for the cultivation of plants, the system comprising:
an upper closed-loop track assembly comprising a track and a drive means for moving the track along a continuous path;
a lower closed-loop path disposed beneath the upper closed-loop track assembly, the lower closed-loop path conforming to the continuous path and extending horizontally outward from the continuous path; and
a plurality of plant receptacles, each plant receptacle having an upper end, a lower end, and a growing portion disposed between the upper and lower ends, the upper end removably suspended from the track and configured to move with movement of the track along the continuous path, the lower end configured to follow passively along the lower closed-loop path, the lower end disposed horizontally outward from the continuous path, the growing portions of the plurality of plant receptacles thereby positioned at an angle to facilitate exposure of the growing portion to an overhead light source.

2. The system of claim 1 wherein the plurality of plant receptacles comprises at least one longitudinal gutter-type plant receptacle.

3. The system of claim 2 wherein the angle formed by the longitudinal gutter-type plant receptacle ranges from 2 degrees to 60 degrees from vertical.

4. The system of claim 2 wherein the angle formed by the longitudinal gutter-type plant receptacle ranges from 5 degrees to 45 degrees from vertical.

5. The system of claim 4 wherein the angle is adjustable.

6. The system of claim 5 wherein the angle is adjustable by positioning the lower end of one or more plant receptacles horizontally outward a predetermined distance from the continuous path.

7. The system of claim 1 wherein the continuous path comprises a serpentine pattern.

8. The system of claim 1 wherein the overhead light source comprises natural lighting.

9. The system of claim 1 wherein the lower closed-loop path has a width extending horizontally outward from the continuous path.

10. The system of claim 1 further comprising at least one plant support frame, wherein the at least one plant support frame is operably coupled to the track and configured to releasably support at least one of the plant receptacles.

11. A system for the cultivation of plants, the system comprising:
an upper closed-loop track assembly comprising a track and a drive means for moving the track along a continuous path;
a lower closed-loop path disposed beneath the upper closed-loop track assembly, the lower closed-loop path conforming to the continuous path and having a width extending horizontally outward from the continuous path;
a plurality of plant support frames, each plant support frame having an upper portion supported by the track, each plant support frame having a lower portion configured to follow passively along the lower closed-loop path, each plant support frame descending downwardly from the upper portion to the lower portion at an angle from vertical, each plant support frame configured to support at least one plant receptacle, each plant support frame configured to move with movement of the track along the continuous path, the lower portion disposed horizontally outward from the continuous path to form the angle, the angle of the plant support frame adjustable to facilitate exposure of the at least one plant receptacle to an overhead light source.

12. The system of claim 11 wherein the plurality of plant support frames is configured to support at least one longitudinal gutter-type plant receptacle.

13. The system of claim 12 wherein at least one bracket is used to releasably support the plant receptacle to the plant support frame.

14. The system of claim 13 wherein the at least one bracket is either an L-bracket or Z-bracket configured to be releasably coupled into one ore more support holes disposed in either or both of the plant support frame and the plant receptacle.

15. The system of claim 11 wherein the angle formed by the plant support frames ranges from 2 degrees to 60 degrees from vertical.

16. The system of claim 15 wherein the angle is adjustable.

17. The system of claim 16 wherein the angle is adjustable by positioning the lower portion of one or more plant support frames horizontally outward a predetermined distance from the continuous path.

18. The system of claim 11 wherein the continuous path comprises a serpentine pattern.

19. The system of claim 11 wherein the overhead light source comprises natural lighting.

20. The system of claim 11 further comprising at least one water supply disposed proximate the upper closed-loop track assembly for supplying water to the at least one plant receptacle.

21. The system of claim 11 further comprising a drainage apparatus disposed proximate the lower closed-loop path for receiving waste.

22. The system of claim 11 wherein at least one of the plurality of plant support frames is configured to support one or more longitudinal gutter-type plant receptacles in a single vertical column arrangement.

23. The system of claim 11 wherein the lower closed-loop path further comprises one or more rails disposed on a surface of the lower closed-loop path, the one or more rails configured to guide one or more carrying idlers coupled to a lower portion of the plant support frame to travel therewithin.
